(19) United States
(12) Patent Application Publication
(10) Pub. No.: US 2012/0165107 A1
(43) Pub. Date: Jun. 28, 2012

(54) FASTENER, DRIVER ENGAGING WITH THE FASTENER AND PUNCH PRODUCING THE FASTENER

(75) Inventors: XIAN-DONG GUO, Shenzhen City (CN); QING-YUN CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/197,910

(22) Filed: Aug. 4, 2011

(30) Foreign Application Priority Data
Dec. 28, 2010 (CN) 201010609166.5

(51) Int. Cl. B21K 1/44; B25B 23/00; F16B 23/00

(52) U.S. Cl. 470/57; 411/402; 81/460

(57) ABSTRACT

A fastener includes a connecting portion and a head portion coaxially connecting with the connecting portion. The head portion defines an engaging hole which includes a main engaging hole and one or more auxiliary engaging hole coaxial with the main engaging hole. A plurality of auxiliary engaging teeth are separately formed on an inner peripheral wall of the engaging hole, toward a central axis of the engaging hole of the head portion, thereby forming the auxiliary engaging hole. A plurality of main engaging teeth are coaxially formed on the auxiliary engaging teeth, toward the central axis of the engaging hole respectively, and are positioned at the base of the engaging hole. The fastener provides two bearing surfaces on which a driver can act upon, and the present disclosure further provides the driver to engage with the fastener and a punch for producing the fastener.

### BACKGROUND

1. Technical Field

The present disclosure relates generally to fasteners, and particularly to a fastener, a driver engaging with the fastener, and a punch for making the fastener.

2. Description of Related Art

Fasteners are widely applied in many fields to attach two objects together. A commonly used fastener generally includes a head portion and a threaded connecting portion extending out from one end of the fastener head portion of the fastener coaxially. The head portion defines a driving engaging hole in one end surface thereof away from the threaded connecting portion. However, the driving engaging hole of the commonly used conventional fastener can be enlarged and deformed through extended use.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings like reference numerals designate corresponding parts throughout the several views. Wherever possible, the same reference numerals are used throughout the drawings to refer to the same or like elements of an embodiment.

FIG. 1 is an isometric view of an embodiment of a fastener together with a driver, wherein, the driver includes a rod portion and a drive portion.

FIG. 2 is an isometric cross sectional view of the fastener of FIG. 1.

FIG. 3 is a top view of the fastener of FIG. 1.

FIG. 4 shows another isometric view of the driver of FIG. 1.

FIG. 5 shows a punch for producing the fastener of FIG. 1.

### DETAILED DESCRIPTION

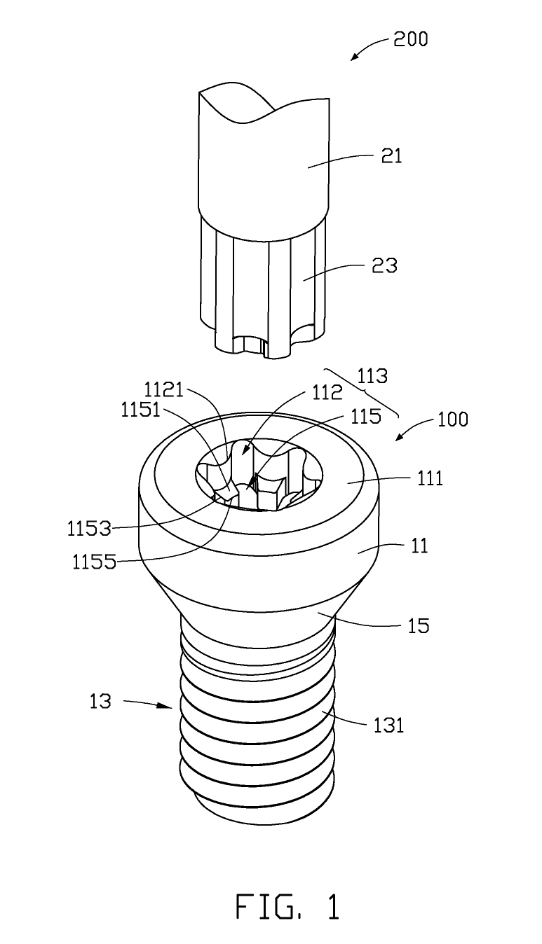

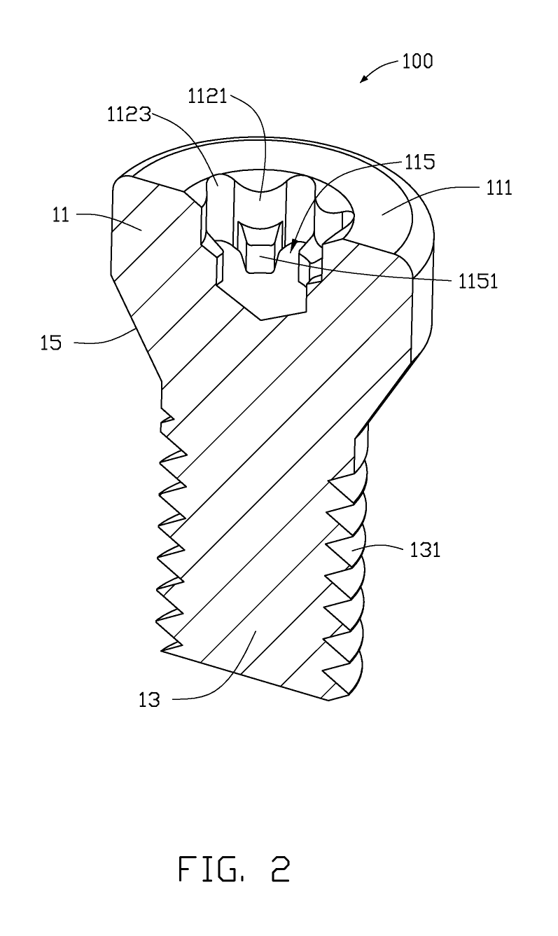

Referring to FIGS. 1 and 2, an embodiment of a fastener 100 includes a head portion 11 and a connecting portion 13 coaxially connected to the head portion 11. The head portion 11 includes an end surface 111 opposite to and positioned away from the connecting portion 13. An engaging hole 113 is defined in the substantially central portion of the end surface 111 of the head portion 11. The connecting portion 13 is a substantially cylindrical threaded rod and defines a plurality of outside threads 131. A conical inclined surface 15 is formed between the head portion 11 and the connecting portion 13 as a transition between the head portion 11 and the connecting portion 13.

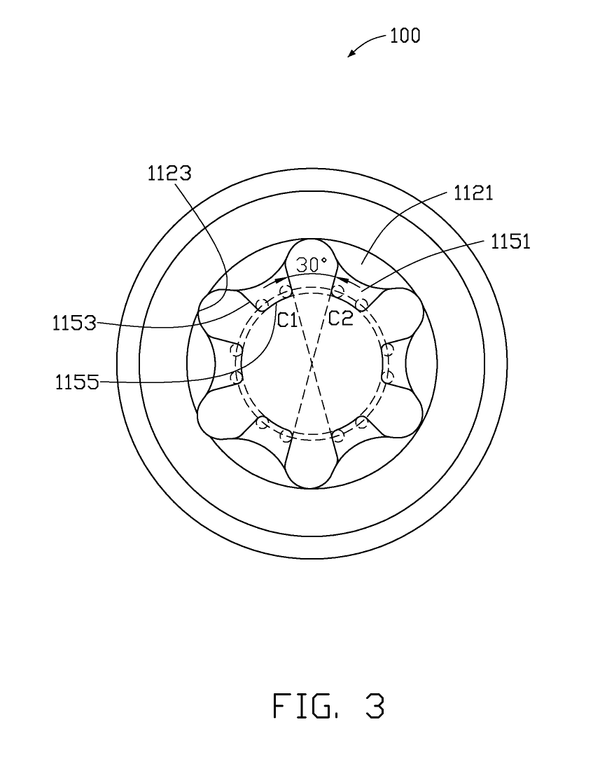

Also referring to FIG. 3, the engaging hole 113 includes a main engaging hole 115 and one or more auxiliary engaging holes 112 coaxial with the main engaging hole 115. In the illustrated embodiment, the main engaging hole 115 is positioned adjacent to a bottom portion of the stepped engaging hole 113 and away from the end surface 111 of the head portion 11. In plan view, the arrangement and configuration of the plurality of auxiliary engaging holes 112 resembles a wave pattern formation formed around a full circle. A plurality of auxiliary engaging teeth 1121 (i.e. the trough of each repeating wave pattern) are formed on an inner peripheral wall of the engaging hole 113 of the head portion 11. All of the auxiliary engaging teeth 1121 equally and separately protrude from the inner peripheral wall of the engaging hole 113 toward the central axis of the engaging hole 113 of the head portion 11. Correspondingly, a plurality of engaging recesses 1123 are formed between every auxiliary engaging tooth 1121 of the teeth 1121, respectively. The plurality of auxiliary engaging teeth 1121 and the plurality of engaging recesses 1123 together with the engaging hole 113 cooperatively define the auxiliary engaging hole 112. A plurality of main engaging teeth 1151 are formed on the auxiliary engaging teeth 1121, respectively, and positioned at the bottom of the engaging hole 113. The plurality of main engaging teeth 1151, together with a bottom portion of the auxiliary engaging hole 112 cooperatively define the main engaging hole 115.

In the illustrated embodiment, the auxiliary engaging hole 112 is a universal torx-type recess defined by a plurality of lobes on either side thereof, and in this embodiment, there are six lobes in all.

In the illustrated embodiment, there are six main engaging teeth 1151. Each main engaging tooth 1151 is substantially a trapezoidal block, and each main engaging tooth 1151 protrudes from an auxiliary engaging tooth 1121, toward the central axis of the head portion 11, and positioned at the bottom of the engaging hole 113. Each main engaging tooth 1151 includes two slanted side surfaces 1153 and a top surface 1155 connecting with the two slanted side surfaces 1153 and positioned away from the corresponding auxiliary engaging tooth 1121. Each slanted side surface 1153 is radially aligned in the head portion 11. The included angle defined by any two adjacent slanted side surfaces 1153 of the main engaging tooth 1151 relative to the center of the engaging hole 113 is substantially 30 degrees. Two ends of the top surface 1155 smoothly connect with the two corresponding adjacent slanted side surfaces 1153.

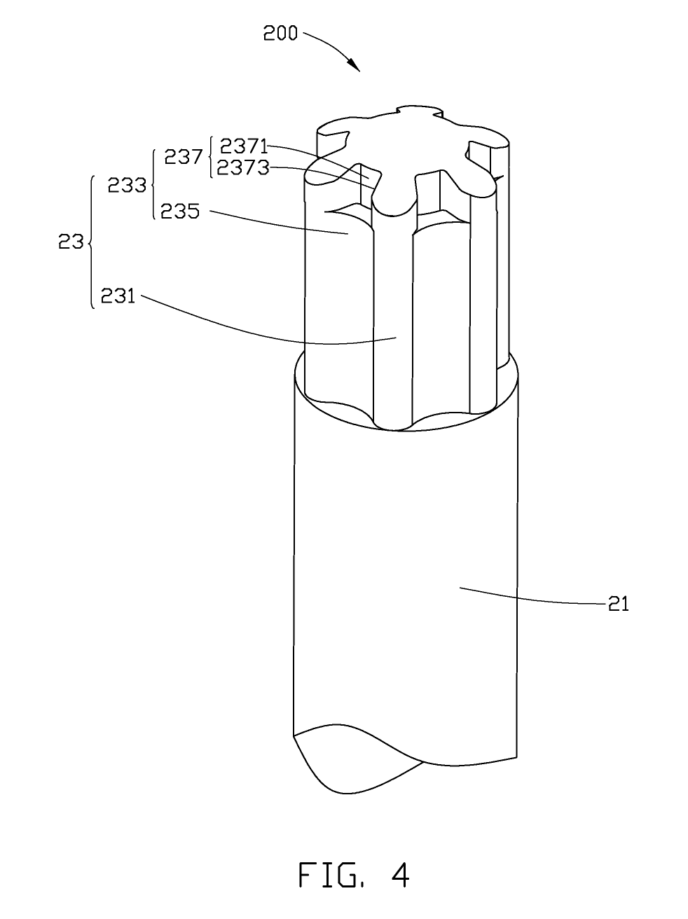

Further referring to FIG. 4, an embodiment of a driver 200 includes a rod portion 21 and a drive portion 23 coaxially extending from one end of the rod portion 21. The drive portion 23 is substantially a torx-type shaft, but stepped as hereinafter described, and has a shape and dimension matching with that of the engaging hole 113 of the head portion 11 of the fastener 100. The drive portion 23 includes a plurality of outer drive teeth 231 and a plurality of engaging slots 233 defined between the outer drive teeth 231, respectively. Each outer drive tooth 231 is substantially bar shaped, having an outer arc surface, and has a shape and dimension matching with the corresponding engaging recess 1123 of the auxiliary engaging hole 112. In the illustrated embodiment, there are six outer drive teeth 231 which are equally spaced, and six engaging slots 233, which are also equally spaced.

Each engaging slot 233 is inwardly stepped at the distal end thereof, and includes an auxiliary engaging slot 235 and a main engaging slot 237 positioned adjacent to the distal end of the auxiliary engaging slot 235 and away from the rod portion 21. Each auxiliary engaging slot 235 has a shape and dimension matching with the corresponding one auxiliary engaging tooth 1121 of the head portion 11 of the fastener 100. The shape and dimensions of each of the main engaging slots 237 match with the corresponding main engaging tooth 1151 of the head portion 11 of the fastener 100. Each main engaging slot 237 includes a bottom surface 2371 and two side resisting surfaces 2373 smoothly connecting with the bottom surface 2371. The bottom surface 2371 and the two side resisting surfaces 2373 cooperatively define the substantially trapezoidal main engaging slot 237.

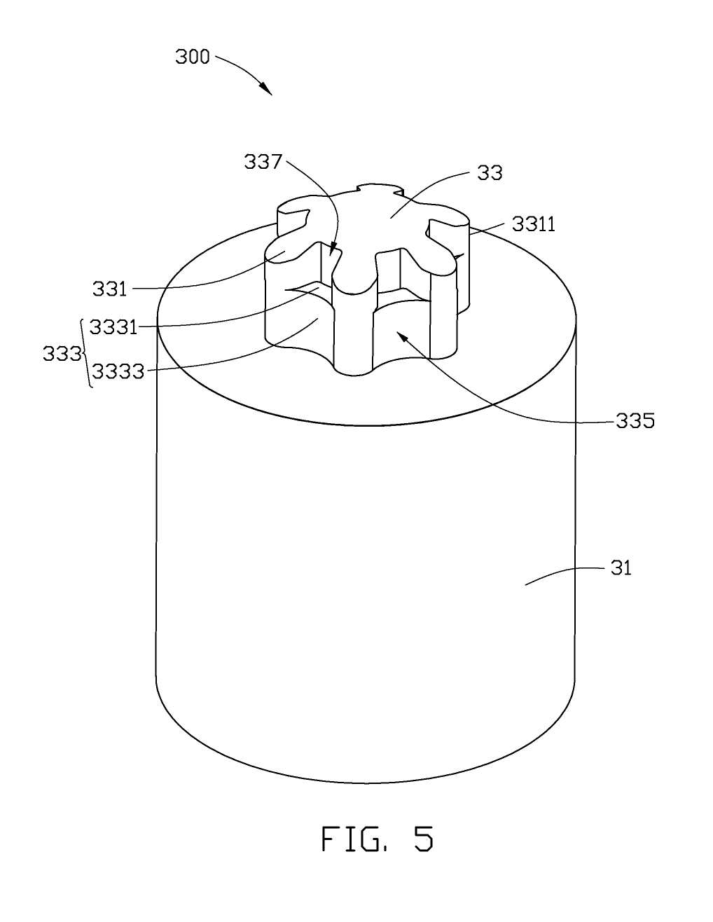

Referring to FIG. 5, an embodiment of a punch 300 for producing the fastener 100 is shown; the punch 300 includes a base body 31, and a punch head 33 formed on one end of the base body 31. The base body 31 is substantially cylindrical in one embodiment. The punch head 33 has the shape and dimension configured to substantially form the engaging hole 113 of the head portion 11 of the fastener 100. The punch head 33 includes a plurality of gear shaped first cutting edges 331 formed on an outer periphery of the punch head 33, thereby forming a first cutting slot 335 between every two first cutting edges 331. A plurality of trapezoidal second cutting slots 337 are coaxially recessed from the bottom portions of the plurality of first cutting slots 335, respectively, and all the second cutting slots 337 are located at the distal end of the punch head 33; thereby forming a second cutting edge 333 between every two first cutting edges 331. Each first cutting edge 331 includes a convex outer surface 3311, for forming the corresponding engaging recess 1123 of the fastener 100. Each second cutting edge 333 has a trapezoidal cross section 3331 and a concave arc-shaped outer surface 3333 for forming the corresponding main engaging tooth 1151 and the auxiliary engaging tooth 1121 of the fastener 100, respectively. The radial width of each first cutting edge 331 is greater than the radial width of each second cutting edge 333, and the axial length of each first cutting edge 331 is greater than the axial length of each second cutting edge 333. In the illustrated embodiment, the total number of the first cutting edges 331 and the second cutting edges 333 are both six.

Also referring to FIGS. 1, 3 and 4, when using the driver 200 to drive the fastener 100, the drive portion 23 of the driver 200 is aligned with and received into the engaging hole 113 of the head portion 11 of the fastener 100. The outer drive teeth 231 of the drive portion 23 engage into the corresponding plurality of engaging recesses 1123 of the engaging hole 113, and are resisted by the corresponding auxiliary engaging teeth 1121. Meanwhile, the auxiliary engaging teeth 1121 and the main engaging teeth 1151 engage with the corresponding auxiliary engaging slots 235 and the main engaging slots 237. The two side resisting surfaces 2373 of each main engaging slot 237 are in contact with the two slanted side surfaces 1153 of each main engaging tooth 1151. A rotational force applied to the driver 200 in a clockwise or counterclockwise direction pushes the fastener 100 to turn as required.

The engaging hole 113 of the fastener 100 is not limited to an inner concaved structure, where the head portion of the fastener 100 can be an external structure similar to that of the drive portion 23 of the driver 200, such that, the driver 200 and the punch 300 may adopt the inner concaved structure which is similar to that of the engaging hole 113.

The fastener 100, the driver 200 and the punch 300 have a simple structure, and are in particular, durable by reason of the particular structure of the engaging hole 113, the outer drive teeth 231 and the punch head 33. As the engaging hole 113 of the fastener 100 is stepped and includes a main engaging hole 115 and an auxiliary engaging hole 112 (of a torx-type recess) coaxial with the main engaging hole 115; the fastener 100 can be rotated even when there is no matching driver 200 available on hand, by using a simple screwdriver with an appropriately-sized tip.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fastener, comprising:
a connecting portion;
a head portion coaxially connected to the connecting portion and having an end surface;
an engaging hole defined in the end surface of the head portion, the engaging hole comprising a main engaging hole and one or more auxiliary engaging hole coaxial with the main engaging hole;
a plurality of auxiliary engaging teeth separately formed on an inner peripheral wall of the engaging hole, respectively, toward a central axis of the engaging hole of the head portion radially, thereby forming the auxiliary engaging hole; and
a plurality of main engaging teeth formed on the auxiliary engaging teeth, toward the central axis of the engaging hole respectively, and positioned at a bottom of the engaging hole; the plurality of main engaging teeth, together with the auxiliary engaging hole cooperatively define the main engaging hole.

2. The fastener as claimed in claim 1, wherein the engaging hole is defined in the substantially central portion of the end surface of the head portion, the engaging hole further comprises a plurality of engaging recesses formed between every two adjacent auxiliary engaging teeth, respectively.

3. The fastener as claimed in claim 1, wherein the connecting portion is a substantially cylindrical threaded rod and defines a plurality of outside threads.

4. The fastener as claimed in claim 1, wherein the fastener further comprises a conical inclined surface formed between the head portion and the connecting portion as a transition between the head portion and the connecting portion.

5. The fastener as claimed in claim 2, wherein the main engaging hole is positioned adjacent to a bottom portion of the stepped engaging hole and away from the end surface of the head portion.

6. The fastener as claimed in claim 5, wherein each main engaging tooth is substantially a trapezoidal block, and comprises two slanted side surfaces and a top surface; each slanted side surface is radially aligned in the head portion; two ends of the top surface smoothly connect with the two slanted side surfaces.

7. The fastener as claimed in claim 6, wherein the auxiliary engaging hole is an universal torx-type recess defined by a total of six lobes, and the lobes are located on either side of each auxiliary engaging hole.

8. The fastener as claimed in claim 7, wherein an included angle defined by two adjacent slanted side surfaces of the main engaging tooth relative to the center of the engaging hole is substantially 30 degrees.

9. A driver for driving the fastener of claim 1, comprising:
a rod portion; and
a drive portion connecting with the rod portion, the drive portion having a shape and dimension matching with that of the engaging hole of the head portion of the fastener;
wherein, the drive portion comprises a plurality of outer drive teeth and a plurality of engaging slots defined between the outer drive teeth, respectively, for engaging with the auxiliary engaging teeth and the main engaging teeth of the fastener.

10. The driver as claimed in claim 9, wherein each engaging slot is inwardly stepped at the distal end, and comprises an auxiliary engaging slot and a main engaging slot positioned adjacent to the distal end of the auxiliary engaging slot.

11. The driver as claimed in claim 10, wherein each auxiliary engaging slot has a shape and dimension matching with the corresponding one auxiliary engaging tooth of the head portion of the fastener; each main engaging slot has a shape and dimension matching with the corresponding one main engaging tooth of the head portion of the fastener.

12. The driver as claimed in claim 11, wherein each main engaging slot comprises a bottom surface and two side resisting surfaces smoothly connecting with the bottom surface; the bottom surface and the two side resisting surfaces cooperatively define the substantially trapezoidal main engaging slot.

13. A punch for producing the fastener of claim 1, comprising:
a base body; and
a punch head formed on one end of the base body, the punch head having a shape and dimension to substantially form the engaging hole of the head portion of the fastener;
wherein, the punch head comprises a plurality of gear shaped first cutting edges formed on an outer periphery of the punch head, thereby forming a plurality of first cutting slots formed between every two adjacent first cutting edges, respectively; and a plurality of second cutting slots coaxially recessed from the bottom portions of the plurality of first cutting slots, respectively, thereby forming a plurality of second cutting edges between every two adjacent first cutting edges, respectively.

14. The punch as claimed in claim 13, wherein each first cutting edge includes a convex outer surface, each second cutting edge has a substantially trapezoidal cross section and a concave arc-shaped outer surface for forming the corresponding main engaging tooth and the auxiliary engaging tooth of the fastener, respectively.

15. The punch as claimed in claim 14, wherein a radial width of each first cutting edge is greater than the radial width of each second cutting edge, and an axial length of each first cutting edge is greater than the axial length of each second cutting edge.
